(19) United States
(12) Patent Application Publication
(10) Pub. No.: US 2013/0311401 A1
(43) Pub. Date: Nov. 21, 2013

(54) METHOD OF ADVANCING FUNDING EXPENSES FOR CAPITAL PROJECTS

(71) Applicant: Lowell Clary, Tallahassee, FL (US)

(72) Inventor: Lowell Clary, Tallahassee, FL (US)

(21) Appl. No.: 13/874,125

(22) Filed: Apr. 30, 2013

Related U.S. Application Data
(60) Provisional application No. 61/640,322, filed on Apr. 30, 2012.

(51) Int. Cl. G06Q 40/06

(52) U.S. Cl. CPC G06Q 40/06
USPC 705/36 R

(57) ABSTRACT

The present teachings relate to a method of financing a government authorized construction project in advance of government scheduled funding. The method may provide a closed loop financing structure for the bond investor. Specifically, a method of financing a construction project in advance of future scheduled funding is shown and described. The method may include the steps of advancing funds for the construction projection by issuing bonds that are non-recourse to a contractor and a public owner hiring the contractor to deliver the construction project, and receiving a performance guarantee for the construction project, where the performance guarantee ensures delivery of the construction project for the public owner upon the contractor's failure to complete the construction project. The method may also include the steps of advancing payment to the construction project as the contractor completes work, and directing payments to a trustee from the future scheduled funding.

### CROSS-REFERENCE TO RELATED APPLICATION

This application claims the benefit from U.S. Provisional Patent Application No. 61/640,322 entitled “Method of Advancing Funding Expenses for Capital Projects” filed on Apr. 30, 3012, which is hereby incorporated in its entirety by reference.

### TECHNICAL FIELD

The present invention generally relates to a method of advance funding of expenses (costs) for a project, and more particularly to a method of advance funding costs of a government authorized construction project in advance of the actual government scheduled funding.

### BACKGROUND

Infrastructure improvements are a major ongoing issue for almost all government entities and related service providers, including Federal, state and local government entities. One of the most challenging aspects of completing infrastructure improvement projects is providing the funding and managing the financing of such. These projects tend to be very expensive, time consuming, and often require very complex financing to complete. This requires government entities to balance the costs of these projects against the public good served by completing the project.

Moreover, due to the expense of these projects and the financing requirements, government entities often schedule the project when funds will be available and not when the project may be desired; especially by the public. This may result in important projects being scheduled many years beyond what is desired. For example, highway widening projects that are needed and would benefit the public immediately may have to be scheduled years out due to the current unavailability of appropriate funding. In this example, the government entities' cash may only be available in future years where these projects are currently scheduled.

It, however, may be beneficial to complete these projects as early as feasible, especially during difficult economic conditions. The government entity may, therefore, benefit from financing to fill the gap created so that the applicable project may begin promptly. Similarly, the pubic at large may benefit from prompt completion of these projects. For example, the Florida Department of Transportation (“FDOT”) and most other departments of transportation operate utilizing an adopted five year work program. From time to time deviations from the work program may be desired by the applicable department of transportation. If, however, the project construction is desired in advance of the programmed time in the adopted five year work program because of political, need or other reason a ‘gap’ will be created if the money is not advanced in the work program to mirror the work commencement.

Unfortunately, cyclical economic downturns, such as the financial crisis that began in 2008, can make it very difficult for cash strapped contractors to borrow funds from banks during periods when credit is scarce or costly. The solutions for interim financing have been extremely limited. Many banks request contractors assume all or a portion of the loan with recourse to the contractor, which has a negative impact on the contractor's balance sheet. Since 2008, times have been tough for the contracting community, which has been forced to consume cash reserves to keep their businesses afloat during these difficult times. If they incur the loan with recourse the contractors' cash reserves and future bidding/bonding capacity are consumed limiting their ability to pursue other projects for the life of the loan, which can be five years or longer. This is a load most, if not all, contractors, which are small and medium sized businesses, simply cannot afford. Additionally, recourse against the contractors creates a liability on the balance sheet of the contractor for the amount of the loan, which affects the contractor's bonding capacity. While this may be acceptable for the period of time during which the work is being performed, it continues to have a negative effect during the gap in time between the completion of the work and receipt of final payment. Specifically, while it may no longer be a liability on the balance sheet, the bonding capacity of the contractor remains adversely affected as it may be tied to the bonding capacity that the applicable department of transportation uses as criteria to award contractors work.

Therefore, there is a need for gap financing that may advance a project to begin immediately resulting in major economic activity that may provide jobs promptly. Further, there is a need for gap financing that may be cost effective, generally avoid negative tax results, and limit certain financial exposure to government entities. Still further, there is a need for gap financing that may permit appropriate competition among contractors that are able to provide performance guarantees.

### SUMMARY

a method of financing a construction project in advance of future scheduled funding is shown and described. The method may include the steps of advancing funds for the construction projection by issuing bonds that are non-recourse to a contractor and a public owner hiring the contractor to deliver the construction project, and receiving a performance guarantee for the construction project, where the performance guarantee ensures delivery of the construction project for the public owner upon the contractor's failure to complete the construction project. The method may also include the steps of advancing payment to the construction project as the contractor completes work, and directing payments to a trustee from the future scheduled funding.

A method of financing a construction project in advance of future scheduled funding is shown and described. The method may include the steps of issuing bonds in amount related to required funding of the construction project, receiving funds from the issuance of the bonds, and advancing payment to a contractor for completed work from the funds of the issued bonds. The method may further include the step of receiving a guarantee of performance from the contractor to a public owner, where the contractor provides a surety bond as the guarantee of performance.

A method of financing a construction project in advance of future funding is shown and described. The method may include the steps of advancing funds for the construction projection by issuing bonds that are non-recourse to a contractor and a public owner hiring the contractor to deliver the construction project, where the funds are held by a trustee, and receiving performance of the construction project from a contractor. The method may include the steps of instructing the trustee to pay the contractor from the advanced funds from the non-recourse bonds as the contractor performs the construction project, and directing payment from the future funding to the trustee at direction of at least one of the contractor, a surety company and the public owner.

### BRIEF DESCRIPTION OF THE DRAWINGS

Operation of the invention may be better understood by reference to the detailed description taken in connection with the following illustrations, wherein:

FIG. 1 is a schematical representation of a flow of funds of embodiments of a method of advancing funding expenses for capital projects.

FIG. 2 is a schematical representation of contracts/agreements that may be required in embodiments of a method of advancing funding expenses for capital projects.

FIG. 3 is a schematical representation of contracts/agreements that may be required in embodiments of a method of advancing funding expenses for capital projects.

FIG. 4 is a schematical representation of a flow of funds of embodiments of a method of advancing funding expenses for capital projects.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

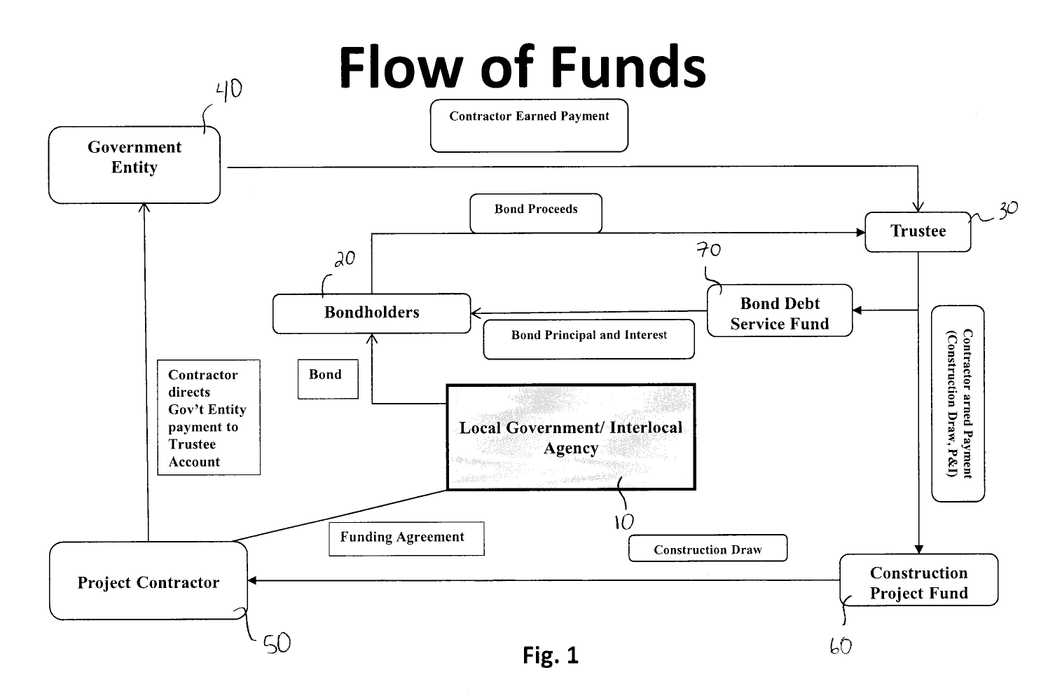

A method of financing a government authorized construction project in advance of government scheduled funding is shown in FIGS. 1-4. The method may include a closed loop advanced financing arrangement for capital projects that may utilize a trustee to manage the funding facilitated by local government/interlocal agency bond issuer. The method may be applied to fund certain government related construction and/or infrastructure projects performed by a contractor, but is not limited to such. The method may be applied to any appropriate financing arrangement. The method may permit a government entity to accelerate a project from the year for which it is currently planned with identified funding to an earlier time that permits the project to start immediately or at least in the near term even though available government funding may be years away. Specifically, the present method of the closed loop financing arrangement may facilitate a government entity to make available in advance certain funds to complete a construction and/or infrastructure improvement project before funding from that government entity may otherwise be available. The present method may permit the advancing of the contractor's obligation to complete a project while generally protecting the financial interests of the parties involved.

More specifically, the present method may provide an interim funding structure that may include a generally tax-exempt limited obligation and non-recourse debt that may be issued by a local government entity. The debt under the present method may be payable solely from payments made by the government entity in the years and amounts provided in the applicable government entity's future payment program. In addition, the present method may include an entity formed by an interlocal agreement. The interlocal agreement may be entered into by at least two government entities forming an entity or by an individual government entity (such as a local government entity), the purpose of which is described in more detail below. By way of a non-limiting example, the interlocal agreement may be entered into by and among counties/cities in which the applicable projects may be located. The entity so formed may serve as the issuer of the debt. In the alternative, a county, or any other applicable government entity, in which the project is located may serve as the issuer of debt for that project such that an interlocal agreement may not be necessary.

The present method may utilize bonds to fund the debt of the applicable project. When the bonds are issued, the capital project may be fully funded, i.e., the bonds may be used to advance the payments of the capital project to the applicable contractor. The payments may be advanced as the contractor “earns” the payment by delivering the work in the same manner the contractor would have government funds been available. The bond holder may then receive payment from the trustee or the applicable government entity in a future date. This may result in the method being a closed loop financing project.

While certain examples of the method of the financing arrangement are shown and described herein, the present teachings are not limited to specific government entities, projects, or types of work shown. The method of the financing arrangement may be used with any applicable government entity, any type of capital project that may require financing, and/or may apply to any kind of work to be performed.

Under the method of the financing arrangement shown and described herein, a government entity may request proposals from private sector teams to accelerate design and construction of a planned future project from the year for which it is currently planned. The identified funding may be moved from future years to an earlier time permitting the project to start immediately such as by way of a non-limiting example, the current fiscal year, or at least in the near term despite available government funding may be years away. The applicable government entity may not be able to fund the project until the year planned, which may require the private sector teams to have available interim financing to begin the project and receive payment from the applicable government entity in the years planned. The present method of the financing arrangement may provide such interim financing in a manner that may be low cost, may reduce certain risks associated with other financing arrangements, and may provide the appropriate financing in advance.

Still further, the present method of financing may allow contractors to participate in the bidding process that may not have otherwise been able to do so previously due to the possibility that they could not self-finance their performance or obtain adequate third-party financing. Specifically, under the present method of financing, contractors may be approved by the applicable government entity and placed on a prequalified list. The present method of financing may be non-recourse—as detailed below—to the contractor so that all prequalified contractors may participate in the bidding process, which may not have otherwise been the case. This may ensure generally competitive bidding for the applicable project, which may generally reduce the costs of such project.

The present method may provide a guarantee of delivery of the project through performance and guarantee bonding. By way of a non-limiting example, such performance and guarantee bonding may be accomplished through surety guarantees provided by the contractor, which may result in financing being available to the surety should a default occur by the contractor. Still further, the fees/expenses may be included in financing—no upfront out-of-pocket charges—all fees to be paid by the project, with no fees charged to the local governmental issuer.

The government entity may benefit from this method of financing because they may take advantage of very favorable construction market conditions where the accelerated project may be delivered at no more and possibly less than the amount currently estimated in the future year of the budgeted work program of projects. The public may benefit because the project improvements may be available to the public at an earlier date. The local area may benefit due to the increased economic activity creating jobs in the local area. The contractor performing the work may benefit because it may earn the work to support its employees and overall business.

An exemplary schematical representation of the flow of funds utilizing the method is shown in FIG. 1. In these exemplary embodiments, an interlocal agency 10 may be formed by at least two government entities—although any number of government entities may form the interlocal agency. The interlocal agency may act as a conduit issuer of applicable bonds. In addition, however, an individual local government may act as an issuer under the present teachings. The bondholders 20 may purchase the bonds and the bonds proceeds may be held by a trustee 30. Another applicable government entity 40, which is the one funding the project in future years, may optionally provide certain currently available funding to the trustee 30. The trustee 30 may hold these funds in trust at the direction of a bond issuer with the contractor 50 performing the services in anticipation of being paid by the trustee 30 as the work is completed. The trustee 30 may hold the funds from the applicable government entity 40 and the bonds in a construction project fund 60 and a bond debt service fund 70. The contractor 50 may then be paid from the construction project fund 60 by the trustee 30 as certified by the applicable government entity 40 that is supervising the work of the contractor 50. Once the applicable funds become available for the project from the government entity 40 in the future budget year, such government entity 40 may transfer such to the trustee 30 at the direction of the contractor 50 via a previously-executed assignment of the future payment to the bond issuer and trustee 30. The trustee 30 may then pay the bondholder 20 from the bond debt service fund from payments made by the governmental entity 40 that is advancing the planned project 70.

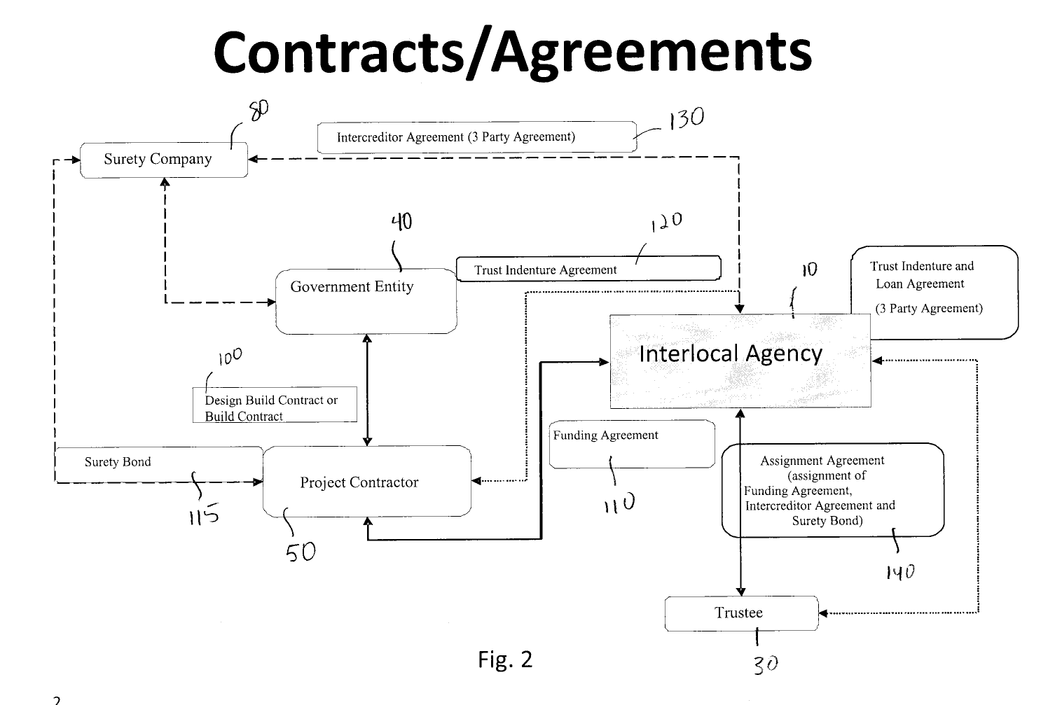

As shown in FIG. 2, the present method may require that certain agreements be entered into by and between the parties mentioned above. While specific examples of agreements are detailed below, the present method is not limited to such agreements. Any appropriate agreement or no agreement at all may be used without departing from the present teachings. Still further, content of these agreements may vary depending upon the specific requirements and embodiments of the present method. Specifically, the present method may include a design build contract 100 between the project contractor 50 and the applicable government entity 40 that is advancing the project. Alternatively, the present method may include a build only contract where a fully designed set of plans are provided by the public owner. The method may include a funding agreement 110 (or a contractor earned payment agreement) or may be entered into between the interlocal agency 10, trustee 30 and the project contractor 50. The project contractor 50 may provide a surety bond 115 from the surety company 80. Still further, the present method may include a trust indenture agreement 120 with the interlocal agency 10 and trustee 30. Alternatively, the surety company 80 may be a direct party or a beneficial party to the funding agreement 110 through an intercreditor agreement 130 as applicable should the project contractor default. The surety company 80, project contractor 50, trustee 30 and interlocal agency 10 may enter into an intercreditor agreement 130. The funding agreement 110 may include an assignment whereby the contractor assigns the funding agreement 110 and the intercreditor agreement 130 to the trustee 30 from the interlocal agency 10. Alternatively, a separate assignment agreement 140 may be entered into by and between the interlocal agency 10 and the trustee 30 whereby the contractor assigns the funding agreement 110 and the intercreditor agreement 130 to the trustee 30 from the interlocal agency 10.

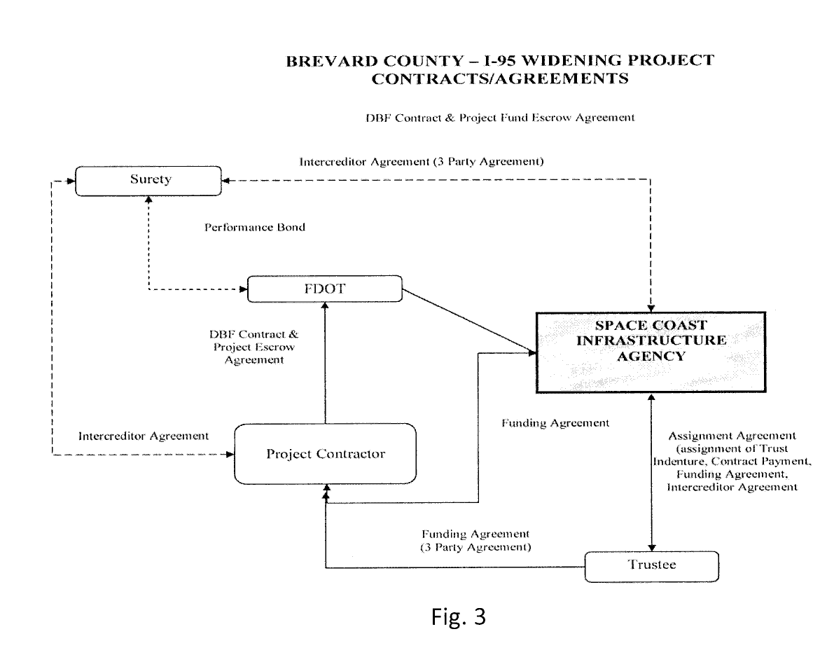

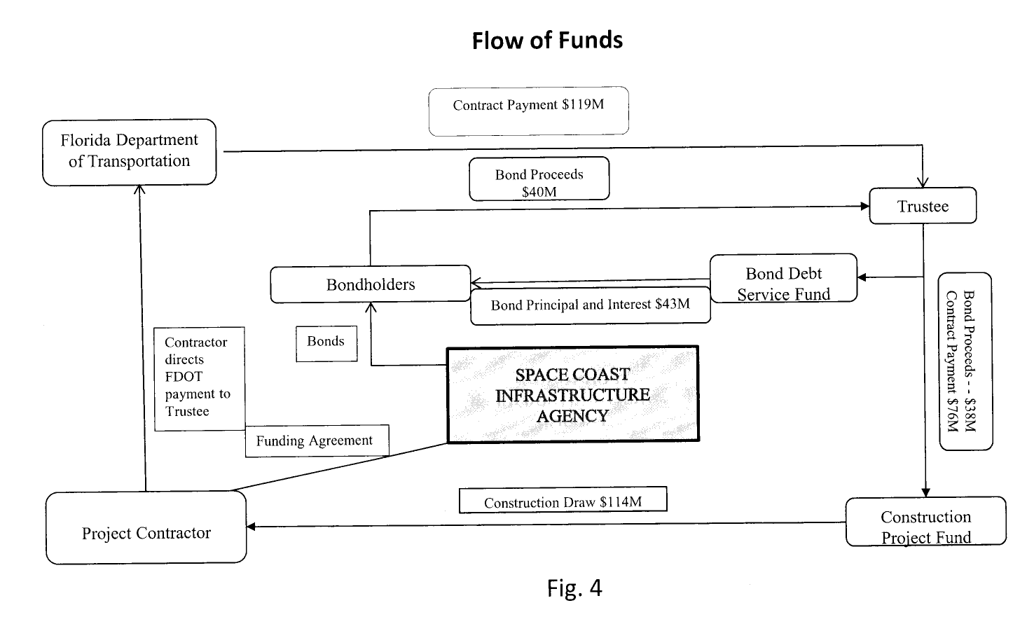

The following are specific exemplary embodiments of the above method of financing arrangement, which are shown in FIGS. 3-4. References to a specific government entity, state, law, or project are merely exemplary and in no way are the present teachings limited to such. By way of a non-limiting example, under the present method an interlocal agency may be formed, such as a Space Coast Infrastructure Agency (the “Agency”) by at least two government entities or this could be by a single government agency as well. The Agency may issue its Infrastructure Improvement Revenue Bonds (I-95 Brevard County DBF Project), Series 2012 as fully registered bonds, without coupons. The bonds, when issued, may be registered in the name of a holder and securities depository nominee (“Nominee”) of a trust company. Individual purchases may be made in book-entry form only through trust company participants in any appropriate principal amount, such as by way of a non-limiting example, $5,000, or any integral multiple thereof. Any appropriate kind of bonds may be used without departing from the present teachings and are not limited to those described herein.

Under this method, the Agency may have been created through an interlocal agreement, such as by way of non-limiting example, an applicable county and a development district. The bonds may then be issued under a trust indenture between the Agency and an applicable trustee. The bonds may be dated their date of delivery, and may bear interest payable over a pre-determined amount of time. The proceeds of the bonds may be held by the trustee.

By way of a non-limiting example, an applicable government entity may have a road widening project located within a particular county to be constructed pursuant to applicable law, such as pursuant to Section 163.01, Florida Statutes (the “Project”). A contractor may have been selected by the government entity for the Project as part of a competitive selection process managed by the government entity. The competitive selection process may include contractors that may not have otherwise been qualified for the process. The contractor may enter into a design build finance contract (the “DBF Contract”) with the government entity prior to delivery of the bonds, contemporaneously therewith or immediately thereafter. The DBF Contract may describe the duties and responsibilities of the contractor and government entity.

The contractor may enter into a funding agreement (the “Funding Agreement”) with the Agency and trustee prior to the delivery of the bonds for the term of the bonds that will be acknowledged by the government entity. The contractor may then provide a payment and performance bond (the “Surety Bond”) to be issued by an appropriate party (the “Surety Bond Provider”). There may be an Intercreditor Agreement (the “Intercreditor Agreement”) to be executed by and among the Agency, contractor, the trustee and the Surety Bond Provider. The Surety Bond may insure the completion of performance by the contractor up to an appropriate amount, but will not insure payment of principal or interest on the bonds. The bonds may be issued to provide immediate funds for the contractor to begin the Project. The bonds may be subject to redemption prior to maturity as appropriate.

More specifically, the present method may include the following steps, which are not limited to the specific order detailed below. The present method may be performed in any appropriate order and certain steps may be combined with other steps, steps may be skipped, and additional steps may be added without departing from the present teachings. Moreover, while the State of Florida is used in the exemplary embodiments, the present teachings are not limited to the State of Florida and may apply to any state, province, municipal government entity, public-private entity, regional authority, the Federal government or the like.

Under the present method of financing arrangement an applicable government entity may be, by way of a non-limiting example, a state agency in the State of Florida (the “State”) established under Section 20.23 of the Florida Statutes to serve as the lead state transportation agency in the State, such as by way of a non-limiting example, the Florida Department of Transportation (“FDOT”). FDOT may have responsibility for the development, operation, and maintenance of the Florida State Highway System. In addition, FDOT may be the lead planning agency for other modes of transportation including public transit, aviation, seaports, rail, and space. FDOT may also be designated as the lead agency for the receipts of funds from the U.S. Department of Transportation (“USDOT”) through the Federal Highway Administration and other modes of transportation that grant funds to the lead state highway agency under federal and state law.

In these specific exemplary embodiments, the State established the State Transportation Trust Fund (“STTF”) under Florida Statutes Section 206.46. The STTF is the major trust fund for FDOT and all Federal grants for transportation uses dedicated to the State and State taxes and fees dedicated to transportation are deposited into the STTF. The major sources of State taxes and fees dedicated to transportation include the motor fuel tax (gas and diesel), aviation fuel tax, and a series of motor vehicle fees including title fees, initial registration fees (charged for each new motor vehicle on the road), registration fees (paid annually or bi-annually), and rental car surcharge. These State taxes and fees are dedicated in law to transportation and these sources are forecasted by a Consensus Revenue Estimating Conference (“REC”) composed of representatives of the Governor's Office, State Senate, House of Representatives, government entity and the collection agencies (Department of Revenue—motor fuels; and Department of Highway Safety and Motor Vehicles—vehicle fees). The REC meets at least twice each year to review the actual receipts compared to the prior forecast and updates the future forecast of revenues expected to be deposited into the STTF over the next ten-year period.

The development of major projects on the Florida State Highway System is managed by FDOT. The development of major transportation projects is a long-term effort that generally takes from 7 to 12 years from start to opening to traffic. This may be done in phases of work including: planning; project development and environment; engineering design; right-of-way acquisition; construction; operations and maintenance. These phases of work may be scheduled and managed through the FDOT Work Program, an automated system that may manage thousands of projects. Projects may be identified in many ways and then prioritized through a comprehensive process established in Federal and State law (e.g., Florida Statutes Sections 339.155 and 339.175). The Work Program may be a multi-year program of projects and project phases (design and construction are each a “phase of work”) that may include active on-going projects and also phases of work planned in the future. FDOT may manages the development of the Work Program of projects that identifies planned future phases of work that may be updated annually based on combination of input such as Federal and State laws and regulations, input from the Metropolitan Planning Agencies (generally counties and cities within a county and a couple of multi-county areas).

Once a major project comes into the Work Program, it may progress through the phases of work based on the input of the local community in a partnership with FDOT. The development of transportation projects involves a major commitment of funds and also public involvement in the community where the project is being planned. By the time a project reaches a design and right-of-way phase of work, the project has been evaluated for key environmental and engineering issues and a decision has been made by a local metropolitan planning organization on the project alignment to move the project forward as a priority. As such, major transportation projects are selected very carefully, thoroughly studied including obtaining public input, and prioritized in a partnership between local elected officials (including the local state representative and senator of the area) and FDOT. This has evolved into a very structured process where projects are identified, studied, and those that are prioritized moving forward in the FDOT Work Program.

Once a major project is headed to design, the scheduling of the project is considered imperative. Thousands of projects are accumulated in the FDOT Work Program and may be managed through a system called the financial management (“FM”) system. The FM system accumulates the FDOT Work Program and provides major summaries of broad categories that form “budget categories” such as “Interstate Construction” for the fiscal year that is a total of all new capacity improvements on the Interstate for that year. These budget categories may be provided to the State Legislature and Executive Office of the Governor for their review and then appropriation for the subsequent fiscal year. This process may be very structured, such as may be required under Section 339.135, Florida Statutes. The processes set in Federal and State law outline the formal structure for adding projects to the FDOT Work Program and then the movement of these forward as the project phases are completed over time. The Legislative appropriation may be the result of this process and may follow in line with the laws established by the Legislature to ensure that projects are developed in a structured manner and protected once prioritized and budget authority is provided to support the project in the years that a project phase is scheduled to be implemented.

In some embodiments of the present method, FDOT may request proposals from design-build private sector teams or contractors that may accelerate the design and construction of a planned future project from the year it is currently budgeted by FDOT in its Work Program to start in an earlier fiscal year, such as by way of a non-limiting example, in the current fiscal year. FDOT, however, may not pay until the year budgeted, so the Design-Build team may need to utilize interim financing to begin the project and receive payment from FDOT in the years budgeted.

FDOT may be able to permit this advanced funding such as through State law. By way of a non-limiting example, the following Florida statute may provide the appropriate authority to FDOT; Section 334.30(1), Florida Statutes, which provides that: “The department may advance projects programmed in the adopted 5-year work program or projects increasing transportation capacity and greater than $500 million in the 10-year Strategic Intermodal Plan using funds provided by public-private partnerships or private entities to be reimbursed from department funds for the project as programmed in the adopted work program.”

In some embodiments, the contractor may have been selected by FDOT for the project as part of a competitive selection process managed by FDOT. The contractor may enter into a DBF Contract, or any other appropriate contractual arrangement, with FDOT before delivery of the bonds. The DBF Contract may describe the duties and responsibilities of the contractor and FDOT as they relate to the project. FDOT may provide a project allocation schedule (the “Project Allocation Schedule”) in the DBF Contract that may detail what monies FDOT has available to make applicable Contract Payments (as defined below). The contractor may not be able to access funds from the Project Allocation Schedule or monies in the Bond Fund (as described herein) until certain construction benchmarks are met and signed-off on by a construction consultant certified by the State. The contractor will only earn payments after the FDOT signs-off on the specific construction benchmarks (the “government entity Contract Payments”). The government entity Contract Payments may include the payment the contractor has earned from the Project construction activities plus bond principal and interest payments then owed. The Funding Agreement may assign the right, title, and interest in the future government entity Contract Payments to the trustee.

FDOT may pay the Contract Payments or the amount shown in the Project Allocation Schedule, which includes monies that have been allocated but not yet paid by FDOT, whichever is less in each quarter. The contractor may enter into the Funding Agreement with the Agency and the trustee before delivery on the bonds for the term of the bonds that will be acknowledged by FDOT. The Project Allocation Schedule and the government entity Contract Payments may be included as separate exhibits within the Funding Agreement.

The contractor may provide a payment and performance bond such as the Surety Bond to be issued by a Surety Bond Provider. There may be an Intercreditor Agreement to be executed by and among the Agency, the contractor, the trustee and the Surety Bond Provider. The contractor may have provided a maximum price that may be needed to complete the project and has committed to deliver the Project for this maximum price, which is memorialized in the DBF Contract. The Surety Bond may provide a financial guarantee up to this maximum price.

Should the contractor fail to adequately perform the outlined duties pursuant to the DBF Contract, the Surety Bond Provider may step-in on behalf of the contractor. The Surety Bond Provider may be responsible for hiring a replacement contractor in a timely manner to ensure the Contract Payments are earned so that such payments are made on time and in approximately the full amount. The Surety may “step-in” to complete the construction of the project and the trustee will be responsible for payments earned by the Surety and the Surety will be responsible for any additional costs beyond the maximum price that might be needed to bring a new contractor in to finish the work not completed by the original contractor due to default. Any changes to the project specifications that may be requested by FDOT will be paid from funds other than those provided by bond proceeds. The present method may result in a generally closed loop system. The financing under this closed loop system may be limited to the amount authorized under the Funding Agreement, which may result in the contractor being responsible for excess expenses.

According to the present method, the Agency may be established to provide interim financing for the project that allows those contractors on the FDOT “Prequalified List” to propose on the project in the Work Program. By providing an alternative for financing, the present method may assist FDOT and an applicable government entity or entities in accelerating the project. This may increase the number of contractors bidding for a project resulting in potentially lower project costs. By way of a non-limiting example, the project may comprise widening of an existing road in a county in the State of Florida. The project under the present method may be conducted as a design-build approach or a design-bid-build approach. The project may be part of a focused phasing of a larger county and state-wide initiative.

The bonds of the present method may be issuable as fully registered bonds, without coupons, in predetermined denominations and/or any integral multiples thereof. By way of a non-limiting example, the bonds may be issued in denominations of $5,000 and any integer multiple thereof. The bonds may be initially issued in the form of a single fully-registered certificate for each maturity. Upon initial issuance, the ownership of the bonds will be registered on the registration books of the Agency (the “Bond Register”) and may be kept by the bond trustee as registrar (the “Bond Registrar”) to evidence the registration and transfer of bonds, in the name of registered owner, as nominee for the depository trust company. Any appropriate bonds may be issued as part of the present method. The present method is not limited to the specific examples of bonds set forth herein; any appropriate bonds may be used.

Interest payments on the bonds may be made to the registered owner thereof appearing on the Bond Register as of the close of business of the Bond Registrar on a predetermined number of days preceding each Interest Payment Date (the “Record Date”). The payments may be made by any suitable means, such as by way of a non-limiting example, by check, wire transfer or draft of the bond trustee, from available amounts in the Interest Fund. The principal of and premium, if any, on the bonds shall be payable upon presentation and surrender thereof at the designated corporate office of the bond trustee, or its successor trustee; provided, however, that for so long as the bonds are registered in the book entry only system maintained by the depository trust company, principal of and interest will be paid directly to the depository trust company, which may in turn remit such payments to the DTC Participants (as described below) for subsequent distribution to the beneficial owners.

Under the present method, the depository trust company may act as securities depository for the bonds. The bonds may be issued as fully registered bonds, registered in the name of a nominee. One fully registered certificate for each series of the bonds may be issued in the aggregate principal amount of the bonds of each maturity thereof and will be deposited with the depository trust company.

By way of a non-limiting example under the present method, the depository trust company may be formed as follows. It should be understood, however, that references to a specific type of entity structure or organization or a particular state law are merely exemplary and the present teachings are not limited to such. The depository trust company may be a limited purpose trust company organized under an applicable state banking law, such as by way of a non-limiting example, New York Banking Law, a “banking organization” within the meaning of the New York Banking Law, a member of the Federal Reserve System, a “clearing corporation” within the meaning of the New York Uniform Commercial Code, and a “clearing agency” registered pursuant to the provisions of Section 17A of the Securities Exchange Act of 1934. The depository trust company may also facilitate the post-trade settlement among Direct Participants of sales and other securities transactions in deposited securities, through electronic computerized book-entry transfers and pledges between Direct Participants' accounts. This may eliminate the need for physical movement of securities certificates.

Under the present embodiments, Direct Participants may include both U.S. and non-U.S. securities brokers and dealers, banks, trust companies, clearing corporations, and certain other organizations. The depository trust company may be a registered clearing agency. Access to the depository trust company system may also be available to others such as both U.S. and non-U.S. securities brokers and dealers, banks, trust companies, and clearing corporations that clear through or maintain a custodial relationship with a Direct Participant, either directly or indirectly (“Indirect Participants”).

Purchases of bonds under the depository trust company system must be made by or through Direct Participants, which will receive a credit for the bonds on the depository trust company's records. The bonds, however, may be purchased and managed in any appropriate manner and are not limited to that shown and described herein. Moreover, the bonds may include any appropriate features or elements as appropriate. Further still, the bonds may be transferred as appropriate and in accordance with any appropriate manner and are not limited to the exemplary descriptions set forth herein.

The bonds of the present method may not be subject to optional redemption. The bonds, however, may be subject to mandatory redemption before their stated dates of maturity in part—such as by lot—on any date. The redemption price may be equal to 100% of the principal amount redeemed, plus accrued interest as of the redemption date from amounts transferred from the Project Fund to the Redemption Account upon amendment of the DBF Contract reducing the aggregate contract price payable by FDOT under the DBF Contract.

The bonds under the present method may be redeemed as appropriate and are not limited to that shown and described herein. By way of a non-limiting example, if any of the bonds are called for redemption, the trustee may give notice, in the name of the Agency, of the redemption of such bonds. The notice may include at least any one of the following: (i) specify the bonds to be redeemed, the redemption date, the redemption price, and the place or places where amounts due upon such redemption will be payable and, if less than all of the bonds are to be redeemed, the numbers of the bonds, and the portions of the bonds, to be redeemed, (ii) state any condition to such redemption or any reservation of the right to rescind such notice, and (iii) state that on the redemption date, and upon the satisfaction of any such condition, the bonds to be redeemed may cease to bear interest.

Under the present method, the bonds may be issued by the Agency under and pursuant to the Indenture. The bonds and all payments to be made by the Agency on such Bonds and into the various funds established under the Indenture may not be general obligations of the Agency but may be special limited obligations payable solely from payments received by the trustee under the Funding Agreement, and amounts on deposit in the funds created under the Indenture (other than the Administrative Expense Fund and the Rebate Fund). The Agency may assign to the trustee substantially all of its right, title and interest in and to the Funding Agreement.

The method may further include creation of a trust fund such as the designated “Space Coast Infrastructure Agency—I-95 Brevard County DBF Project Fund” (referred to herein as the “Project Fund”) and may be established by the Indenture. Pursuant to the Indenture, there may be two separate subaccounts created and established in the Project Fund, the “Bond Proceeds Account” and the “government entity Contract Payments Account.” The trustee may, from time to time, establish such additional accounts in the Project Fund as may be requested by the Agency, or as otherwise may be required. Moneys received from the investment of moneys in the Project Fund may be deposited into the Project Fund. Upon the issuance and delivery of the bonds, a portion of the proceeds of the bonds, may be deposited in the Bond Proceeds Account of the Project Fund.

Still further under the method, after debt service payments, proceeds received from FDOT Contract Payments required to be deposited to the credit of FDOT Contract Payments Account of the Project Fund pursuant to the Indenture may be deposited in the FDOT Contract Payments Account of the Project Fund. The FDOT Contract Payments may be made only upon certified completion of phases of the project by the contractor. The FDOT Contract Payments in the Schedule of the Indenture may be subject to change, as applicable based on the actual work of the contractor during the term of the DBF Contract.

The trustee may disburse the moneys in the Project Fund to pay the applicable contractor, or the Surety for work earned as approved by the government owner (FDOT), as the case may be, for the construction of the project and performance under the DBF Contract. Such disbursement may be made in accordance with the Funding Agreement. Still further, such disbursements may be made first from amounts on deposit in the Bond Proceeds Account of the Project Fund and then from the FDOT Contract Payments Account of the Project Fund.

Upon receipt of notice from the applicable contractor pursuant to the Funding Agreement that the DBF Contract has been amended to reduce the aggregate contract price payable thereunder by FDOT, the trustee may transfer from the Project Fund to the Redemption Account an applicable amount. Such amount may be equal to the amount of the reduction of the aggregate contract price payable by FDOT under the DBF Contract, to be applied to the redemption of bonds pursuant to the Indenture. Any such transfer may first be made from the FDOT Contract Payments Account of the Project Fund and then from the Bond Proceeds Account of the Project Fund. Upon completion of the project, as may be determined in accordance with the Funding Agreement excess funds remaining in the Project Fund after payment or provision for payment of all remaining costs of the Project pursuant to the Funding Agreement, may be applied as appropriate and any remaining balance may be transferred to the Redemption Account to be applied to the redemption of bonds pursuant to the Indenture.

In addition to the Project Fund, there may be trust funds such as the designated “Space Coast Infrastructure Agency—I-95 Brevard County DBF Revenue Fund” (referred to herein as the “Revenue Fund”), “Space Coast Infrastructure Agency—I-95 Brevard County DBF Bond Fund” (referred to herein as the “Bond Fund”), “Space Coast Infrastructure Agency—I-95 Brevard County DBF Administrative Expense Fund” (referred to herein as “Administrative Expense Fund”) and “Space Coast Infrastructure Agency—I-95 Brevard County DBF Rebate Fund” (referred to herein as the “Rebate Fund”). There may be created and established five accounts in the Bond Fund designated the “Interest Account,” the “Capitalized Interest Account,” the “Principal Account,” the “Redemption Account” and the “Reserve Account.” The moneys in each of such Funds and the Accounts in the Bond Fund may be held by the trustee in trust and applied as provided in the Indenture and, pending such applications, other than the Administrative Expense Fund and the Rebate Fund may be subject to a lien and charge in favor of the owners of the bonds and the trustee. The establishment of accounts set forth above is merely exemplary and the present teachings are not limited to a specific number of accounts or funds. Any appropriate number of accounts or funds may be used without departing from the present teachings, such as for example, one, two, three, four or more.

Still further under the present method and pursuant to the Funding Agreement, the contractor may have directed and conveyed all of its right, title and interest in and to the FDOT Contract Payments to the Trustee. Pursuant to the FDOT Payment Escrow Agreement, the Contractor may have directed FDOT to deposit all payments by FDOT under the DBF Contract to the credit of the Revenue Fund. Amounts deposited to the credit of the Revenue Account may be transferred upon receipt to the Project Fund and the Bond Fund in accordance with an applicable schedule of the Indenture until the cumulative amounts provided for deposit to the credit of the Project Fund pursuant to the applicable schedule of the Indenture may have been deposited. Thereafter, all amounts deposited to the credit of the Revenue Account may be transferred upon receipt to the credit of the Bond Fund.

Amounts deposited to the credit of the Bond Fund may be transferred on or before a predetermined day of each month as follows: (a) to the credit of the Interest Account, the Principal Account and the Redemption Account, without distinction as to priority, until the amounts on deposit therein are equal to the aggregate amount of interest, principal and mandatory sinking fund installments coming due on the bonds—which may be in the current bond year; (b) to the credit of the Reserve Account, the amount necessary to cause amounts on deposit therein to equal the Reserve Requirement; (c) to the credit of the Administrative Expense Fund, the amount necessary to pay Administrative Expenses in excess of the amounts then on deposit in the Administrative Expense Fund—by way of a non-limiting example, fund Administrative Expenses coming due in the bond year; (d) to the credit of the Rebate Fund, the amount, if any, necessary to pay the Rebate Amount; and (e) all amounts on deposit in the Bond Fund due to the receipt of FDOT Contract Payments earlier than as contemplated by the applicable schedule to the Indenture may be deposited to the credit of the Redemption Account and applied to redeem bonds pursuant to the Indenture. To the extent, however, that any amounts deposited in the Bond Fund may not be required to be used to make deposits or to be transferred pursuant to sections (a) through (e) above, such amounts may be retained in the Bond Fund and may be applied to make future deposits and transfers as required by the Indenture.

Moreover, according to the present method moneys on deposit in the Interest Account may be used for the payment of interest on the bonds, and moneys on deposit in the Principal Account may be used for the payment of maturing principal of the bonds. At the maturity date of each bond and at the redemption date and the due date of each mandatory sinking fund installment and installment of interest on each bond, the trustee may transfer amounts from the Interest and Principal Accounts and the Redemption Account set aside for such purpose as provided in the Indenture, to a special account with sufficient moneys to pay all principal of and interest then due and payable with respect to each such bond. Moneys so transferred into the special accounts may not thereafter be invested in any manner but may be held by the trustee without liability on the part of the trustee for interest thereon until actually paid out for the purposes intended.

Moneys held for the credit of the Redemption Account in the Bond Fund may be applied with reasonable diligence. The moneys may be used to first make up any deficiency in the Interest Account and Principal Account and then for the retirement of bonds pursuant to the terms of the Indenture. The trustee may call bonds then subject to redemption in such amount as permitted under the Indenture as may exhaust the money in the Redemption Account as nearly as possible. Such redemption may be made pursuant to the provisions of the applicable Indenture. On the redemption date, the trustee may withdraw from the Interest Account and from the Redemption Account and set aside in separate accounts the respective amounts that may be required for paying the interest on and principal of the bonds or portion of bonds so called for redemption. If, however, the trustee may at any time be unable to exhaust the moneys in the Redemption Account through the redemption of bonds as provided above, such moneys or the balance of such moneys may be retained in the Redemption Account and, as soon as it is feasible, applied to the redemption of bonds.

Upon the issuance of the bonds, an amount equal to the Reserve Requirement may be deposited to the credit of the Reserve Account. The “Reserve Requirement” may mean an amount equal to the maximum quarterly interest payment requirement coming due in the current or any future bond year with respect to the bonds. Moneys on deposit in the Reserve Account may, subject to the replenishment terms provided herein, at all times be in an amount equal to the Reserve Requirement and be used, to the extent necessary, to make up any deficiencies in the Bond Fund relating to the timely payment of principal of and interest on the bonds. If, however, on any Interest Payment Date or date on which principal of bonds may be due and payable, the Bond Fund may not contain sufficient moneys to pay the principal of and interest on the bonds due and payable on such date, the trustee may transfer moneys from the Reserve Account to the Bond Fund, to the extent of such deficiency. Amounts necessary to replenish the Reserve Account to the Reserve Requirement may be replenished from amounts available from time to time for transfer to the Reserve Account pursuant to the Indenture. On the Business Day next preceding the final payment of all outstanding bonds, at scheduled maturity or upon early redemption, the trustee may transfer any amounts in the Reserve Account to the Bond Fund for application toward the payment of the principal of and premium, if any, on such bonds. Further, amounts on deposit in the Capitalized Interest Account may be transferred to the Interest Account to fund amounts that may be required to be deposited to the credit of the Interest Account pursuant to the Indenture prior to the application of moneys otherwise available in the Bond Fund. Still further, amounts on deposit in the Administrative Expense Fund may be applied by the trustee to pay Administrative Expenses as may be directed by the Issuer.

Further, according to the present method, amounts on deposit in the Rebate Fund may be applied by the trustee to pay the Rebate Amount (as may be defined in Indenture). Pursuant to the Indenture, the trustee may deposit into the Rebate Fund the amount that may be necessary to increase the balance in the Rebate Fund to the Rebate Amount. The amount may come from at least any one of the following: from investment earnings on moneys deposited in the other Funds and Accounts created under the Indenture or from any other funds held by the trustee and available for such purpose, or from other moneys paid by the Contractor to the trustee for such purpose. The trustee may apply amounts on deposit in the Rebate Fund to make all required payments to the United States of America of the Rebate Amount as may be determined by the Rebate Consultant. To the extent the funds held by the trustee in the Rebate Account are not sufficient to make payments of such Rebate Amount; the contractor may pay to the trustee an amount necessary to make up such deficiency. In complying with the foregoing, the trustee and contractor may rely upon any instructions from and any opinions of an applicable bond counsel, including, without limitation, a letter or instructions that may be delivered by an applicable bond counsel to the Agency and the contractor on the date of issuance of the bonds, and upon any certificates, opinions or calculations prepared by the Rebate Consultant.

Still further, in making any distribution from the Rebate Fund held under the Indenture if, based upon the written calculations provided by the Rebate Consultant, the funds remaining therein subject to the terms of the Indenture may not be sufficient to pay the Rebate Amount when due, the Contractor may promptly pay the deficiency to the trustee. Any such payments to be made to the United States of America as required under the Indenture may be made directly by the trustee from the Rebate Fund, or any other fund or account held under the Indenture, or from funds provided by the contractor upon, and in such amounts as provided in written instructions from the Rebate Consultant to the trustee, notwithstanding any other requirements to the contrary.

If any amount remains in the Rebate Fund after payment in full of the bonds and after payment in full to the United States of the Rebate Amount, which may be required under law, with respect to the bonds in accordance with the terms hereof, the trustee may first apply such amounts to reimburse the contractor for amounts provided by the contractor for the payment of the Rebate Amount and any remaining funds shall be paid to FDOT. In some embodiments of the present method, and notwithstanding any other provisions of the Indenture, the obligation to pay the Rebate Amount to the United States may survive the defeasance or payment in full of the bonds.

All funds and accounts created under the Indenture according to the present method may be impressed with a lien to secure prompt payment of the Rebate Amount. This may be before the lien created under the Indenture for the benefit of the bondholders and further by a lien to reimburse the trustee for any expense (including reasonable attorneys' fees) incurred by it pursuant, which lien may also be prior to the lien created under the Indenture for the benefit of the bondholders.

The covenants that support the repayment of the bonds for both principal and interest may include the funds on deposit with the trustee. In addition, the contractor may direct that all future payments from the government entity (FDOT) to the trustee so that as the contractor delivers the work on the project and is paid by the trustee this generates a future amount due from the government entity (FDOT) under the DBF Contract in the same amount. Further, the contractor may provide a Letter of Credit from a bank rated by an international rating agency at “A” or higher in the amount of the cost of bond issuance, annual administrative cost for the term of the advance financing (Trustee, Rebate Calculation Consultant, Rating Agency updates); a time period of interest on the bonds (up to 15 months), plus an additional contingency amount generally of $150,000 pledged to the benefit of the Trustee. The above three items may collectively ensure that at any given point from the time the bonds are issued until the bondholders are fully paid there is over 100% available to repay the bondholders, subject to the future payment from the governmental entity (FDOT) for amount earned by the contractor.

The “credit structure” of the advance financing achieved an investment grade rating from the Fitch Rating Agency for the Space Coast Infrastructure Agency I-95 Volusia County DBF Project.

The contractor may provide a maximum price that may be needed to complete the project and has committed to deliver the project for this maximum price. The Surety Bond may provide a financial guarantee up to this maximum price. Should the contractor fail to adequately perform the outlined duties pursuant to the DBF Contract, the Surety Bond Provider may step-in on behalf of the contractor to complete the project and will have access to the project financing amount on deposit with the trustee up to the maximum price. In the event the Surety Bond Provider steps-in on behalf of the contractor and the maximum price is insufficient to finish the project, the Surety Bond Provider may be responsible to complete the project and fund any difference necessary to do so.

The difference between the maturity amount of the bonds maturing on a first predetermined date (the “Discount Bonds”), and the initial offering price to the public, excluding bond houses, brokers or similar persons or organizations acting in the capacity of underwriters or wholesalers, at which price a substantial amount of the Discount Bonds of the same maturity was sold may be the “original issue discount.” The original issue discount may accrue over the term of the Discount Bonds at a constant interest rate compounded periodically. A purchaser who acquires the Discount Bonds in the initial offering at a price equal to the initial offering price thereof to the public will be treated as receiving an amount of interest excludable from gross income for federal income tax purposes equal to the original issue discount accruing during the period he or she holds the Discount Bonds, and will increase his or her adjusted basis in the Discount Bonds by the amount of such accruing discount for purposes of determining taxable gain or loss on the sale or disposition of the Discount Bonds. The federal income tax consequences of the purchase, ownership and redemption, sale or other disposition of the Discount Bonds that are not purchased in the initial offering at the initial offering price may be determined according to rules that differ from those above.

The difference between the principal amount of the bonds maturing on a second predetermine date, which may be later than the first predetermined date set forth above (collectively, the ‘Premium Bonds“), and the initial offering price to the public (excluding bond houses, brokers or similar persons or organizations acting in the capacity of underwriters or wholesalers) at which price a substantial amount of such Premium Bonds of the same maturity was sold may constitute to an initial purchaser amortizable bond premium that may not deductible from gross income for federal income tax purposes. The amount of amortizable bond premium for a taxable year may be determined actuarially on a constant interest rate basis over the term of each of the Premium Bonds, which ends on the earlier of the maturity or call date for each of the Premium Bonds that may minimize the yield on such Premium Bonds to the purchaser. For purposes of determining gain or loss on the sale or other disposition of a Premium Bond, an initial purchaser who acquires such obligation in the initial offering may be required to decrease such purchaser's adjusted basis in such Premium Bond annually by the amount of amortizable bond premium for the taxable year. The amortization of bond premium may be taken into account as a reduction in the amount of tax-exempt income for purposes of determining various other tax consequences of owning such Premium Bonds.

Under the present method, interest paid on tax-exempt bonds such as the bonds may be subject to information reporting to the Internal Revenue Service in a manner similar to interest paid on taxable obligations. This reporting requirement may not affect the excludability of interest on the bonds from gross income for federal income tax purposes. However, in conjunction with that information reporting requirement, certain requirements may require certain non-corporate owners of bonds, under certain circumstances, to “backup withholding” at (i) the fourth lowest rate of tax applicable under Section 1(c) of the IRS Tax Code (i.e., a rate applicable to unmarried individuals) for taxable years beginning on or before December 31, of the applicable year; and (ii) the rate of 31% for taxable years beginning after December 31, of the applicable year, with respect to payments on the bonds and proceeds from the sale of bonds. Any amount so withheld may be refunded or allowed as a credit against the federal income tax of such owner of bonds. This withholding may generally apply if the owner of bonds (i) fails to furnish the payor such owner's social security number or other taxpayer identification number (“TIN”), (ii) furnished the payor an incorrect TIN, (iii) fails to properly report interest, dividends, or other “reportable payments” as defined in the IRS Tax Code, or (iv) under certain circumstances, fails to provide the payor or such owner's securities broker with a certified statement, signed under penalty of perjury, that the TIN provided is correct and that such owner is not subject to backup withholding.

The method of providing advanced financing for constructions projects identified above may provide the following benefits: advances the project, resulting in major economic activity providing jobs; provides gap financing at the lowest cost via generally Tax-Exempt funding, which saves tax dollars; ensures maximum competition—all contractors approved by government entity eligible to compete for the project; project delivery guaranteed by 100% Performance Bond supplied by the contractor; all fees/expenses included in financing—no upfront or out-of-pocket charges required from local government or the contractor; non recourse to local governments and the contractor; advanced funding is available to the Surety should contractor default and the Surety “steps-in” to complete the project; and the financial structure provides a “closed loop” that may ensure the bondholders have full backing of their repayment during the entire time of the advanced financing.

Additional embodiments of a method of advanced financing for constructions projects of the present teachings are described below. In the descriptions, all of the details and components may not be fully described or shown. Rather, the features, step or components are described and, in some instances, differences with the above-described embodiments may be identified. Moreover, it should be appreciated that these other embodiments may include elements, steps or components utilized in the above-described embodiments although not shown or described. Thus, the descriptions of these other embodiments are merely exemplary and not all-inclusive nor exclusive. Moreover, it should be appreciated that the features, components, elements and functionalities of the various embodiments may be combined or altered to achieve a desired method of advanced financing for constructions projects without departing from the spirit and scope of the present invention.

The method identified above may be performed via a computer and applicable software programs. The steps identified above of the present method, or any one of the steps of the method, may be automated based upon information that may be inputted into the applicable software program by a user. The applicable software program may be written such that the variables identified above may be entered by a user. Once the variables are entered, the software program may utilize certain algorithms that may output the necessary documents and information identified above. By way of a non-limiting example, the software program may output the required contracts and agreements set forth above. The applicable boilerplate language may be added to the software program such that the deal specific variables may be entered and the applicable contracts may be outputted from the software. Still further, portions of any of the steps or any one of the steps identified above may be included within the software program. The present teachings are not limited to a specific amount of automation completed by the applicable software program.

Still further, the present method may be used with any state agencies, such as by way of a non-limiting example a department of transportation or any state or local government. This may include any of the 50 states, the District of Columbia, Puerto Rico or any other applicable local government entity. Moreover, the present teachings are not limited to the department of transportation. The present method may be applied to any agency or department of an applicable government entity. Still further, the present teachings are not limited to construction projects. The method may be applied to any project that may require advanced funding.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. A method of financing a construction project in advance of future scheduled funding, the method comprising the steps of:
advancing funds for the construction projection by issuing bonds that are non-recourse to a contractor and a public owner hiring the contractor to deliver the construction project;
receiving a performance guarantee for the construction project, wherein the performance guarantee ensures delivery of the construction project for the public owner upon the contractor's failure to complete the construction project;
advancing payment to the construction project as the contractor completes work; and
directing payments to a trustee from the future scheduled funding.

2. The method of claim 1, wherein the bonds are issued by a government entity that is not the public owner.

3. The method of claim 1, wherein the performance guarantee is provided by a surety company.

4. The method of claim 1, further comprising the steps of:
the public owner making payment to the trustee based on completion of the construction project and occurrence of the future scheduled funding; and
the trustee paying bondholders upon maturation of the bonds.

5. The method of claim 1, wherein the performance guarantee includes the contractor purchasing a surety bond guaranteeing the contractor's performance wherein payment of the bonds is ensured.

6. The method of claim 5, wherein upon the contractor failing to perform the construction project a surety company hires a second contractor to complete the construction project.

7. The method of claim 6, wherein upon the contractor failing to perform the construction project the surety company funds the second contractor.

8. The method of claim 7, further comprising the step of using bond proceeds to fund an increased amount charged by the second contractor above the funds advanced.

9. The method of claim 1, further comprising the step of the public owner approving the advancement of payment to the construction project as the contractor completes work.

10. The method of claim 1, wherein the contractor, surety company and public owner direct payments to the trustee from the future scheduled funding.

11. A method of financing a construction project in advance of future scheduled funding, the method comprising the steps of:
issuing bonds in amount related to required funding of the construction project;
receiving funds from the issuance of the bonds;
advancing payment to a contractor for completed work from the funds of the issued bonds; and
receiving a guarantee of performance from the contractor to a public owner, wherein the contractor provides a surety bond as the guarantee of performance.

12. The method of claim 10, further comprising the steps of:
directing payments from the public owner for completed work on the construction project to a trustee, wherein the trustee holds the funds; and
paying holders of the bonds by the trustee upon maturation of the bonds from the funds.

13. The method of claim 12, wherein directing payments to the trustee is funded from the future scheduled funding.

14. The method of claim 11, further comprising the steps of:
a government agency issuing the bonds;
entering into a funding agreement between the contractor and the public owner, wherein the contractor is obligated to construct the construction project;
advancing funds to the construction project to pay the contractor when it completes work as evidenced by approvals from the public owner;
the contractor irrevocably directing future payments from the public owner to a trustee; and
entering into an intercreditor agreement between a surety company, the contractor and the trustee wherein the surety company assumes the contractor's obligations from the funding agreement upon the contractor failing to complete the construction project.

15. A method of financing a construction project in advance of future funding, the method comprising the steps of:
advancing funds for the construction projection by issuing bonds that are non-recourse to a contractor and a public owner hiring the contractor to deliver the construction project, wherein the funds are held by a trustee;
receiving performance of the construction project from a contractor;
instructing the trustee to pay the contractor from the advanced funds from the non-recourse bonds as the contractor performs the construction project; and
directing payment from the future funding to the trustee at direction of at least one of the contractor, a surety company and the public owner.

16. The method of claim 15, further comprising the steps of:
the public owner making payment to the trustee based on completion of the construction project and occurrence of the future scheduled funding; and
the trustee paying bondholders upon maturation of the bonds.

17. The method of claim 15, further comprising the step of requesting proposals from qualified potential contractors, wherein the qualified potential contractors are not disqualified based upon debt from completing the construction project.

18. The method of claim 15, further comprising the step of the contractor providing a guarantee of performance from a surety company, wherein the performance guarantee ensures delivery of the construction project upon the contractor's failure to complete the construction project.

19. The method of claim 18, wherein the performance guarantee ensures payment of the bonds from future payments from the public owner.

20. The method of claim 18, wherein the guarantee of performance provided by the surety company enhances credit worthiness of the contractor.

21. The method of claim 18, further comprising the steps of:
the contractor irrevocably directing future payments from the public owner to the trustee; and
entering into an intercreditor agreement between the surety company, the contractor and the trustee wherein the surety company assumes the contractor's obligations to complete the construction project upon the contractor failing to complete the construction project.
